(19) United States
(12) Patent Application Publication
(10) Pub. No.: US 2016/0073132 A1
(43) Pub. Date: Mar. 10, 2016

(54) Method of Simplified View Synthesis Prediction in 3D Video Coding

(71) Applicant: Mediatek Singapore Pte. Ltd., Singapore (SG)

(72) Inventors: Na ZHANG, Shangqiu City, Henan Province (CN); Yi-Wen CHEN, Taichung City (TW); Jian-Liang LIN, Su'ao Township, Yilan County (TW); Jicheng AN, Beijing City (CN); Kai ZHANG, Beijing (CN)

(73) Assignee: Media Tek Singapore Pte. Ltd., Singapore (SG)

(21) Appl. No.: 14/785,000

(22) PCT Filed: Jul. 18, 2014
(86) PCT No.: PCT/CN2014/082528

§ 371 Date: Oct. 16, 2015

(30) Foreign Application Priority Data
Jul. 19, 2013 (CN) PCT/CN2013/079668

(51) Int. Cl. H04N 19/597; H04N 19/176; H04N 19/103

(52) U.S. Cl. CPC H04N 19/597; H04N 19/103; H04N 19/176

(57) ABSTRACT

A method of three-dimensional video encoding or decoding that uses unified depth data access for VSP process and VSP-based merging candidate derivation is disclosed. When the coding tool corresponds to VSP process or VSP-based merging candidate, embodiments of the present invention fetch the same reference depth data in a reference view. A reference depth block in a reference view corresponding to the current texture CU is fetched using a derived DV (disparity vector). For the VSP process, first VSP data for a current PU (prediction unit) within the current CU is generated based on the reference depth block. For the VSP-based merging candidate derivation, second VSP data for a VSP-coded spatial neighboring PU associated with a VSP spatial merging candidates is generated also based on the reference depth block.

### CROSS REFERENCE TO RELATED APPLICATIONS

The present application is a national stage application of PCT/CN2014/082528, filed Jul. 18, 2014, which is a continuation in part of PCT Patent Application, Serial No. PCT/CN2013/079668, filed on Jul. 19, 2013, entitled “Simplified View Synthesis Prediction for 3D Video Coding”. The PCT Patent Application is hereby incorporated by reference in its entirety.

### TECHNICAL FIELD

The present invention relates to three-dimensional video coding. In particular, the present invention relates to depth data access associated with view synthesis prediction in 3D video coding.

### BACKGROUND

Three-dimensional (3D) television has been a technology trend in recent years that intends to bring viewers sensational viewing experience. Various technologies have been developed to enable 3D viewing. Among them, the multi-view video is a key technology for 3D TV application among others. The traditional video is a two-dimensional (2D) medium that only provides viewers a single view of a scene from the perspective of the camera. However, the multi-view video is capable of offering arbitrary viewpoints of dynamic scenes and provides viewers the sensation of realism.

The multi-view video is typically created by capturing a scene using multiple cameras simultaneously, where the multiple cameras are properly located so that each camera captures the scene from one viewpoint. Accordingly, the multiple cameras will capture multiple video sequences corresponding to multiple views. In order to provide more views, more cameras have been used to generate multi-view video with a large number of video sequences associated with the views. Accordingly, the multi-view video will require a large storage space to store and/or a high bandwidth to transmit. Therefore, multi-view video coding techniques have been developed in the field to reduce the required storage space or the transmission bandwidth.

A straightforward approach may be to simply apply conventional video coding techniques to each single-view video sequence independently and disregard any correlation among different views. Such coding system would be very inefficient. In order to improve efficiency of multi-view video coding, multi-view video coding exploits inter-view redundancy. Various 3D coding tools have been developed or being developed by extending existing video coding standard. For example, there are standard development activities to extend H.264/AVC (advanced video coding) and HEVC (high efficiency video coding) to multi-view video coding (MVC) and 3D coding.

Various 3D coding tools developed or being developed for 3D-HEVC and 3D-AVC are reviewed as follows.

To share the previously coded texture information of adjacent views, a technique known as Disparity-Compensated Prediction (DCP) has been included in 3D-HTM (test Model for three-dimensional video coding based on HEVC (High Efficiency Video Coding)) as an alternative coding tool to motion-compensated prediction (MCP). MCP refers to an inter-picture prediction that uses previously coded pictures of the same view, while DCP refers to an inter-picture prediction that uses previously coded pictures of other views in the same access unit. FIG. 1 illustrates an example of 3D video coding system incorporating MCP and DCP. The vector (110) used for DCP is termed as disparity vector (DV), which is analog to the motion vector (MV) used in MCP. FIG. 1 illustrates three MVs (120, 130 and 140) associated with MCP. Moreover, the DV of a DCP block can also be predicted by the disparity vector predictor (DVP) candidate derived from neighboring blocks or the temporal collocated blocks that also use inter-view reference pictures. In current 3D-HTM, when deriving an inter-view Merge candidate for Merge/Skip modes, if the motion information of corresponding block is not available or not valid, the inter-view Merge candidate is replaced by a DV.

Inter-view motion prediction is used to share the previously encoded motion information of reference views. For deriving candidate motion parameters for a current block in a dependent view, a DV for current block is derived first, and then the prediction block in the already coded picture in the reference view is located by adding the DV to the location of current block. If the prediction block is coded using MCP, the associated motion parameters can be used as candidate motion parameters for the current block in the current view. The derived DV can also be directly used as a candidate DV for DCP.

Inter-view residual prediction is another coding tool used in 3D-HTM. To share the previously coded residual information of adjacent views, the residual signal of the current prediction block (i.e., PU) can be predicted by the residual signals of the corresponding blocks in the inter-view pictures. The corresponding blocks can be located by respective DVs. The video pictures and depth maps corresponding to a particular camera position are indicated by a view identifier (i.e., V0, V1 and V2). All video pictures and depth maps that belong to the same camera position are associated with the same viewId (i.e., view identifier). The view identifiers are used for specifying the coding order within the access units and detecting missing views in error-prone environments. An access unit includes all video pictures and depth maps corresponding to the same time instant. Inside an access unit, the video picture and, when present, the associated depth map having viewId equal to 0 are coded first, followed by the video picture and depth map having viewId equal to 1, etc. The view with viewId equal to 0 (i.e., V0) is also referred to as the base view or the independent view. The base view video pictures can be coded using a conventional HEVC video coder without dependence on other views.

For the current block, motion vector predictor (MVP)/disparity vector predictor (DVP) can be derived from the inter-view blocks in the inter-view pictures. In the following, inter-view blocks in inter-view picture may be abbreviated as inter-view blocks. The derived candidate is termed as inter-view candidates, which can be inter-view MVPs or DVPs. The coding tools that codes the motion information of a current block (e.g., a current prediction unit, PU) based on previously coded motion information in other views is termed as inter-view motion parameter prediction. Furthermore, a corresponding block in a neighboring view is termed as an inter-view block and the inter-view block is located using the disparity vector derived from the depth information of current block in current picture.

View Synthesis Prediction (VSP) is a technique to remove inter-view redundancies among video signal from different viewpoints, in which synthetic signal is used as references to predict a current picture. In 3D-HEVC test model, HTM-7.0, there exists a process to derive a disparity vector predictor, known as NBDV (Neighboring Block Disparity Vector). The derived disparity vector is then used to fetch a depth block in the depth image of the reference view. The procedure to derive the virtual depth can be applied for VSP to locate the corresponding depth block in a coded view. The fetched depth block may have the same size of the current prediction unit (PU), and it will then be used to do backward warping for the current PU. In addition, the warping operation may be performed at a sub-PU level precision, such as 2×2, 4×4, 8×4 or 4×8 blocks.

In current implementation, VSP is only applied for texture component coding. Also the VSP prediction is added as a new merging candidate to signal the use of VSP prediction. In such a way, a VSP block may be a skipped block without any residual, or a Merge block with residual information coded. The VSP-based merging candidate may also be referred as VSP merging candidate for convenience in this disclosure.

When a picture is coded as B picture and the current block is signaled as VSP predicted, the following steps are applied to determine the prediction direction of VSP:
Obtain the view index refViewIdxNBDV of the derived disparity vector from NBDV;
Obtain the reference picture list RefPicListNBDV (either RefPicList0 or RefPicList1) that is associated with the reference picture with view index refViewIdxNBDV;
Check the availability of an interview reference picture with view index refViewIdx that is not equal to refViewIdxNBDV in the reference picture list other than RefPicListNBDV;
   If such a different interview reference picture is found, bi-direction VSP is applied. The depth block from view index refViewIdxNBDV is used as the current block's depth information (in case of texture-first coding order), and the two different interview reference pictures (each from one reference picture list) are accessed via backward warping process and further weighted to achieve the final backward VSP predictor;
   Otherwise, uni-direction VSP is applied with RefPicListNBDV as the reference picture list for prediction.

When a picture is coded as a P picture and the current prediction block is using VSP, uni-direction VSP is applied.

VSP is used as a common DCP candidate for the following modules: temporal merging candidate derivation, motion parameter inheritance for depth coding, depth oriented neighboring block disparity vector (DoNBDV), adaptive motion vector prediction (AMVP), and deblocking filter. The derivation of the VSP merging candidate checks the spatial neighboring blocks belonging to a selected spatial neighboring set to determine whether any spatial neighboring block in the set is coded as a VSP mode. As shown in FIG. 2, five spatial neighboring blocks (B0, B1, B2 A0 and A1) of the current block (210) belonging to the set for derivation of the VSP merging candidate. The current block may be a coding unit (CU) or a prediction unit (PU). Among the neighboring blocks in the set, blocks B0, B1 and A1 are VSP coded. To infer whether a spatial neighbor of current PU is VSP coded, a reconstruction of merging candidate set for the neighboring block is needed. The Merge index of the neighboring block is also required and has to be stored. If the current PU is located adjacent to the top boundary (220) of a largest coding unit (LCU) or coding tree unit (CTU), the reconstruction of the neighboring block from a neighboring LCU or CTU will be required as shown in FIG. 2. Therefore, a line buffer may be required to store the merging candidate set associated with blocks at lower boundary of the upper neighboring LCU or CTU row.

It is noted that, in the current design, when constructing the merging candidate list, if a spatial neighbor of current PU utilizes the VSP mode, NBDV of the spatial neighbor and the VSP mode are inherited from the spatial neighbor. Then NBDV of the spatial neighbor will be used to fetch a depth block in the depth image of the reference view for performing VSP process for current PU as shown in FIGS. 3A-3C.

FIG. 3A, illustrates the depth data access for a current CU based on DoNBDV. Block 310 is a current CU in the current picture of the current view. The DoNBDV process utilizes the depth map in an inter-view reference picture pointed by NBDV to derive a refined DV. As shown in FIG. 3A, block 310′ is at a location of the collocated depth block corresponding to the current texture CU (310). The depth block 320 is located based on location 310′ and the derived DV (322) according to the NBDV process.

FIG. 3B illustrates an example of depth map access for VSP merging candidate derivation. In this case, NBDV of the spatial neighbor and the VSP mode for the current PU are inherited from the spatial neighbor. The NBDV of the spatial neighbor may be different from the NBDV of the current CU. Therefore, the NBDV of the spatial neighbor may point to different depth blocks of the inter-view reference pointed by the NBDV of the current CU. For example, the NBDVs of the spatial neighbors are indicated by references 332 and 342 and the depth blocks to be retrieved are indicated by reference numbers 330 and 340 as shown in the left side of FIG. 3B. Therefore, additional depth data has to be accessed in order to derive the VSP merging candidate. Furthermore, the NBDV of the spatial neighbor may point to a depth map other than the inter-view reference picture pointed by the NBDV of the current CU as shown in the right side of FIG. 3B, where the derived DV (352) points to a depth block (350).

FIG. 3C illustrates yet another example of depth map access for VSP merging candidate derivation, where the CU is split into two PUs (360a and 360b). The DVs (372a and 372b) of respective neighboring PUs of PU 360a and PU 360b may be different from each other. Furthermore, DVs 372a and 372b may also be different from the NBDV of the current CU. Therefore, different depth data from DoNBDV has to be retrieved to perform VSP processing, including deriving the VSP merging candidate, for the current PU.

As described above, the DV is critical in 3D video coding for inter-view motion prediction, inter-view residual prediction, disparity-compensated prediction (DCP), backward view synthesis prediction (BVSP) or any other tools which need to indicate the correspondence between inter-view pictures. The DV derivation utilized in current test model of 3D-HEVC version 7.0 (HTM-7.0) is described as follow.

In the current 3D-HEVC, the disparity vectors (DVs) used for disparity compensated prediction (DCP) are explicitly transmitted or implicitly derived in a way similar to motion vectors (MVs) with respect to AMVP (advanced motion vector prediction) and merging operations. Currently, except for the DV for DCP, the DVs used for the other coding tools are derived using either the neighboring block disparity vector (NBDV) process or the depth oriented neighboring block disparity (DoNBDV) process as described below.

In the current 3D-HEVC, a disparity vector can be used as a DVP candidate for Inter mode or as a Merge candidate for Merge/Skip mode. A derived disparity vector can also be used as an offset vector for inter-view motion prediction and inter-view residual prediction. When used as an offset vector, the DV is derived from spatial and temporal neighboring blocks as shown in FIGS. 4A-4B. Multiple spatial and temporal neighboring blocks are determined and DV availability of the spatial and temporal neighboring blocks is checked according to a pre-determined order. This coding tool for DV derivation based on neighboring (spatial and temporal) blocks is termed as Neighboring Block DV (NBDV). The temporal neighboring block set, as shown in FIG. 4A, is searched first. The temporal merging candidate set includes the location at the center of the current block (i.e., B_{CTR}) and the location diagonally across from the lower-right corner of the current block (i.e., RB) in a temporal reference picture. The temporal search order starts from RB to B_{CTR}. Once a block is identified as having a DV, the checking process will be terminated. The spatial neighboring block set includes the location diagonally across from the lower-left corner of the current block (i.e., A0), the location next to the left-bottom side of the current block (i.e., A1), the location diagonally across from the upper-left corner of the current block (i.e., B2), the location diagonally across from the upper-right corner of the current block (i.e., B0), and the location next to the top-right side of the current block (i.e., B1) as shown in FIG. 4B. The search order for the spatial neighboring blocks is (A1, B1, B0, A0, B2).

If a DCP coded block is not found in the neighboring block set (i.e., spatial and temporal neighboring blocks as shown in FIGS. 4A and 4B), the disparity information can be obtained from another coding tool, named DV-MCP. In this case, when a spatial neighboring block is MCP coded block and its motion is predicted by the inter-view motion prediction, as shown in FIG. 5, the disparity vector used for the inter-view motion prediction represents a motion correspondence between the current and the inter-view reference picture. This type of motion vector is referred to as inter-view predicted motion vector and the blocks are referred to as DV-MCP blocks. FIG. 5 illustrates an example of a DV-MCP block, where the motion information of the DV-MCP block (510) is predicted from a corresponding block (520) in the inter-view reference picture. The location of the corresponding block (520) is specified by a disparity vector (530). The disparity vector used in the DV-MCP block represents a motion correspondence between the current and inter-view reference picture. The motion information (522) of the corresponding block (520) is used to predict motion information (512) of the current block (510) in the current view.

To indicate whether a MCP block is DV-MCP coded and to store the disparity vector for the inter-view motion parameters prediction, two variables are used to represent the motion vector information for each block:
dvMcpFlag, and
dvMcpDisparity.

When dvMcpFlag is equal to 1, the dvMcpDisparity is set to indicate that the disparity vector is used for the inter-view motion parameter prediction. In the construction process for the AMVP mode and Merge candidate list, the dvMcpFlag of the candidate is set to 1 if the candidate is generated by inter-view motion parameter prediction and is set to 0 otherwise. If neither DCP coded blocks nor DV-MCP coded blocks are found in the above mentioned spatial and temporal neighboring blocks, then a zero vector can be used as a default disparity vector.

A method to enhance the NBDV by extracting a more accurate disparity vector from the depth map is utilized in current 3D-HEVC. A depth block from coded depth map in the same access unit is first retrieved and used as a virtual depth of the current block. To be specific, the refined DV is converted from the maximum disparity of the pixel subset in the virtual depth block which is located by the DV derived using NBDV as shown in FIG. 3. This coding tool for DV derivation is termed as Depth-oriented NBDV (DoNBDV).

Under the current scheme, due to VSP mode and motion information inheriting from the spatial neighbor, it may need to access multiple depth blocks in multiple reference views for performing VSP process for the current PU. Also VSP mode flags may have to be stored in a line memory in order to determine whether the spatial neighbor of the current PU is VSP coded or not. Therefore, it is desirable to develop a method for the VSP process that can simplify the process or reduce the required storage.

### SUMMARY

A method of three-dimensional video encoding or decoding that uses unified depth data access for VSP process and VSP-based merging candidate derivation is disclosed. When the coding tool corresponds to VSP process or VSP-based merging candidate, embodiments of the present invention fetch the same reference depth data in a reference view. A reference depth block in a reference view corresponding to the current texture CU is fetched using a derived DV (disparity vector). For the VSP process, first VSP data for a current PU (prediction unit) within the current CU is generated based on the reference depth block. For the VSP-based merging candidate derivation, second VSP data for a VSP-coded spatial neighboring PU associated with a VSP spatial merging candidates is generated also based on the reference depth block. The current PU is encoded or decoded using the first VSP data if the VSP mode is used, or using the second VSP data if the Merge mode is used and the VSP merging candidate is selected.

The derived DV may be derived using NBDV (neighboring block disparity vector), where a selected DV derived from neighboring blocks of the current texture CU is used as the derived DV. The derived DV may be derived using DoNBDV (depth oriented NBDV), where the NBDV is derived first and the depth data in a reference view pointed by the NBDV is converted to a disparity value and used as the derived DV.

First reference texture data in an inter-view reference picture corresponding to the current PU can be generated according to disparity converted from the reference depth block. The first reference texture data is used as the first VSP data. Second reference texture data in an inter-view reference picture corresponding to the VSP-coded spatial neighboring PU can be generated according to disparity converted from the reference depth block. The second reference texture data is then used as the second VSP data. The first reference texture data and the second reference texture data may also be identical in some embodiments.

For multiple VSP spatial merging candidates, the candidates are checked for redundancy, and any redundant VSP merging candidate that is identical to another VSP merging candidate is removed from the a merging candidate list. The checking can be based on partial set of or full set of the VSP spatial merging candidates.

### BRIEF DESCRIPTION OF DRAWINGS

FIG. 1 illustrates an example of three-dimensional video coding incorporating disparity-compensated prediction (DCP) as an alternative to motion-compensated prediction (MCP).

FIG. 2 illustrates an example of spatial neighboring blocks of the current block belonging to a set for derivation of the VSP merging candidate.

FIG. 3A illustrates an example of the depth data access for a current CU (Coding Unit) based on DoNBDV (Depth-oriented Neighboring Block Disparity Vector).

FIG. 3B illustrates another example of depth map access for VSP merging candidate derivation, where NBDV (Neighboring Block Disparity Vector) of the spatial neighbor and the VSP mode are inherited from the spatial neighbor.

FIG. 3C illustrates yet another example of depth map access for VSP merging candidate derivation, where the CU (Coding Unit) is split into two PUs and the DVs (Disparity Vectors) of respective neighboring PUs (Prediction Units) of the two PUs are different from each other.

FIGS. 4A-4B illustrate respective temporal neighboring blocks and spatial neighboring blocks of a current block for deriving a disparity vector for the current block.

FIG. 5 illustrates an example of a disparity derivation from motion-compensated prediction (DV-MCP) block, where the location of the corresponding blocks is specified by a disparity vector.

FIG. 6 illustrates an example of constrained depth data accessed by VSP (View Synthesis Prediction) according to an embodiment of the present invention.

FIG. 7 illustrates an exemplary of constrained VSP information inheritance according to an embodiment of the present invention, where a spatial neighbor coded with VSP is referred as a common DCP candidate for spatial merging candidate derivation if the VSP-coded neighbor crosses the LCU boundary.

FIG. 8 illustrates an exemplary flowchart of three-dimensional video encoding and decoding that uses constrained depth data access associated with VSP (View Synthesis Prediction) according to an embodiment of the present invention.

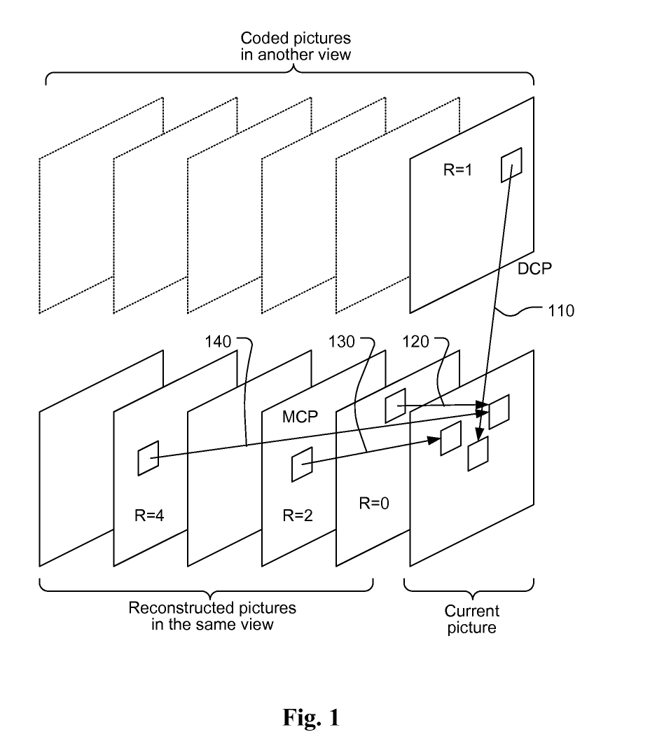

### DETAILED DESCRIPTION

As described above, due to the VSP mode and motion information inheriting from the spatial neighbor according to conventional 3D-HEVC (Three-dimensional coding based on HEVC (High Efficiency Video Coding)), it may need to access multiple depth blocks in multiple reference views for performing VSP process for the current PU. Also VSP mode flags may have to be stored in a line memory in order to determine whether the spatial neighbor of the current PU is VSP coded. Accordingly, embodiments of the present invention simplify the VSP process.

In the first embodiment of the present invention, for VSP mode inheritance, if the selected spatial candidate is derived from a VSP-coded spatial neighbor block, the current PU will be coded as VSP mode, i.e., inheriting the VSP mode from a neighboring block. However, the NBDV of the neighboring block will not be inherited. Instead, the DV derived by NBDV for the current CU will be used to fetch a depth block in the reference view for all PUs in the current CU. It is noted that, in current 3D-HEVC, a CU level NBDV is used to derive a DV for all PUs within the same CU. According to the first embodiment, VSP mode inheritance also uses the same derived DV using NBDV for the current PU. Therefore, the same depth data will be accesses for VSP process using DoBNDV or using VSP mode inheritance.

In the second embodiment of the present invention, for VSP mode inheritance, if the selected spatial candidate is derived from a VSP-coded spatial neighbor block, the current PU will be coded as VSP mode, i.e., inheriting the VSP mode of a neighboring PU. However, the NBDV of the neighboring block will not be inherited. Instead, the DV derived by NBDV for the current CU will be used to fetch a depth block in the reference view. There may be multiple identical VSP candidates in the merging candidate list. The method according to the second embodiment will perform partial checking for the VSP mode of spatial merging candidates similar to comparisons between motion information of spatial neighbors. For example, when B1 is a spatial VSP merging candidate, if B0 is also VSP coded, B0 will not be added to the merge candidate list. This pairwise comparison is denoted as B0→B1. Other comparisons, such as B1→A1, A0→A1, B2→A1 and B2→B1 may also be used.

In the third embodiment of the present invention, for VSP mode inheritance, if the selected spatial candidate is derived from a spatial neighbor block coded as VSP mode. However, the NBDV of the neighboring block will not be inherited. Instead, the DV derived by NBDV for the current CU will be used to fetch a depth block in the reference view. There may be multiple identical VSP candidates in the merging candidate list. The method according to the third embodiment will perform full checking for VSP mode of spatial merging candidates. For example, before adding a spatial VSP merging candidate to the merging candidate list, checking will be performed to determine if there is already a VSP-coded spatial merging candidate or VSP merging candidate existing in the merging candidate list. If a VSP-coded spatial merging candidate or VSP merging candidate exists, the spatial VSP merging candidate will not be added, which ensures that there will be at most one VSP merging candidate in the merging candidate list.

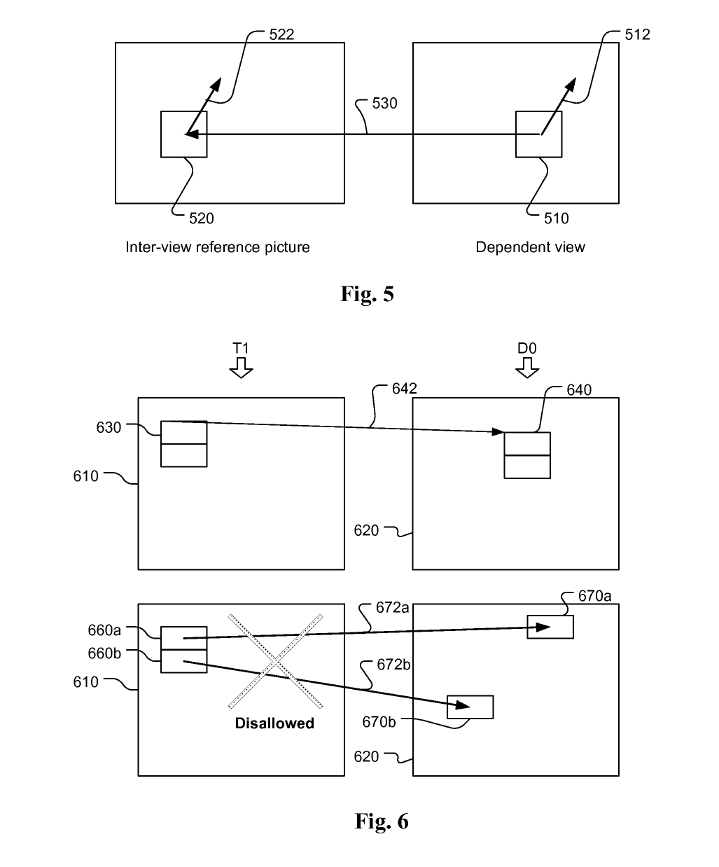

All of the above embodiments ensure that the VSP merging candidate uses the derived NBDV of the current CU instead of using the DV from neighboring blocks to fetch a depth block in the reference view. The constraint on the depth data accessed by VSP is shown in FIG. 6. CU/PU 630 is in the current texture picture (T1) of a dependent view (view 1, 610). Derived DV 642 is determined using NBDV or DoNBDV for the current CU/PU (630) to access a depth block 640 in a reference depth map (620) pointed by the NBDV or DoNBDV (642). On the other hand, the VSP merging candidate derivation would use derived DVs (672a and 672b) of neighboring blocks of the current PUs (660a and 660b) to access depth blocks (670a and 670b) in the reference depth map (620). Embodiments according to the present invention disallow the use of derived DV from neighboring blocks when VSP merging candidate is selected for the current CU/PU. Instead, embodiments according to the present invention use the DV derived for the current CU instead of inheriting the DV from a neighboring block when a VSP merging candidate is selected.

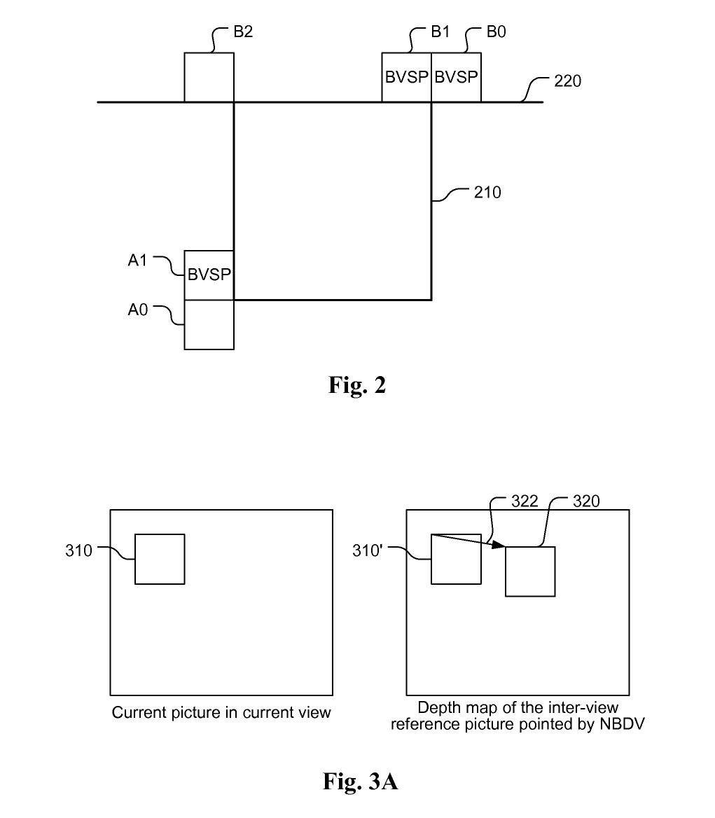

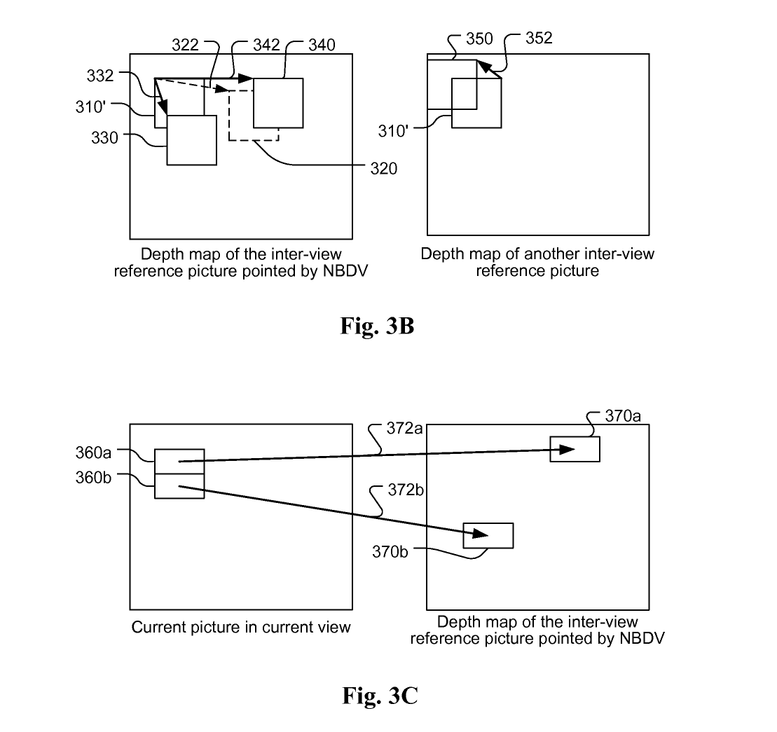

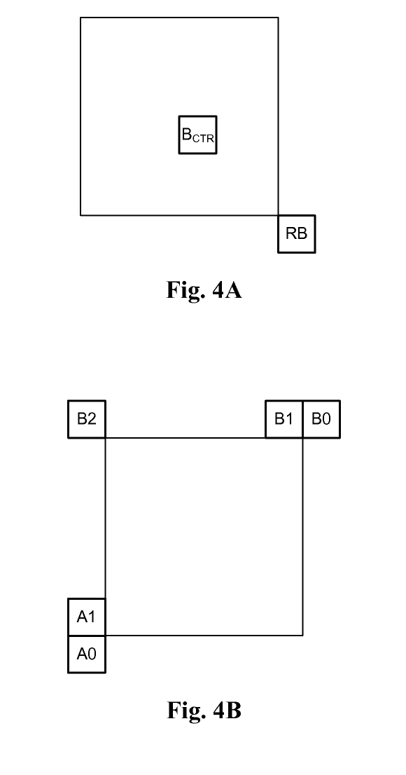

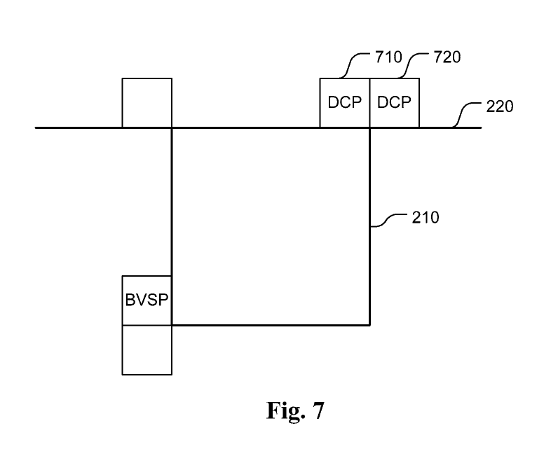

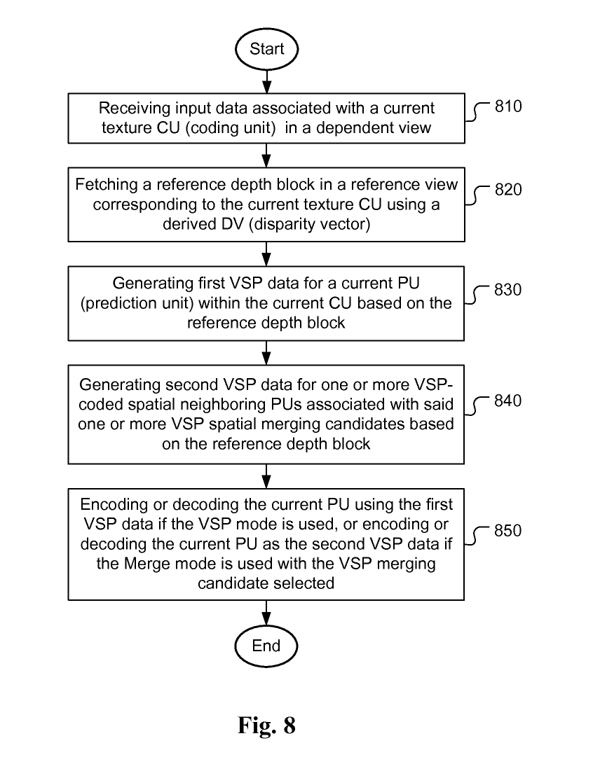

In the fourth embodiment, the VSP mode is prohibited from inheriting the DV and VSP mode of the spatial merge candidate derived from neighboring blocks above a LCU row boundary. When a neighboring block above the LCU row boundary is coded in the VSP mode and the spatial merging candidate is derived from this neighboring block, this spatial merging candidate will be treated as a common DCP candidate with the DVs and reference index stored for a VSP coded block. FIG. 7 illustrates an example, where two spatial neighboring blocks (710 and 720) are coded in the VSP mode. In a conventional approach, when the two neighboring blocks above the LCU row boundary of a current CU are coded using VSP mode as shown in the example of FIG. 2, the DV and VSP mode flag for these two blocks have to be stored in order to derive VSP merging candidate for the current block. However, the example of the fourth embodiment as shown in FIG. 7 uses a common DCP for these two VSP coded blocks. Therefore, there is no need to store the DVs and the VSP flags associated with neighboring block above the LCU row boundary. In other word, the fourth embodiment of the present invention can save the line buffer required for the DVs and the VSP flags associated with neighboring block above the LCU row boundary.

Embodiments of the present invention force the VSP merging candidate to use DoNBDV as used by VSP to locate depth data in the reference view to derive the VSP merging candidate. This constraint offers the advantage of reducing the amount of depth data access since the depth access for VSP process and VSP-based merging candidate derivation is unified. Nevertheless, this constraint may cause system performance degradation. A system incorporating unified depth data access for unified VSP process and VSP-based merging candidate derivation according to an embodiment of the present invention is compared to a conventional system (3D-HEVC Test Model version 8.0 (HTM 8.0)) as shown in Table 1. The performance comparison is based on different sets of test data listed in the first column. The BD-rate measurement is a well-known performance measure in the field of video coding system. The BD-rate differences are shown for texture pictures in view 1 (video 1) and view 2 (video 2). A negative value in the BD-rate implies that the present invention has a better performance. As shown in Table 1, the system incorporating embodiments of the present invention shows a small BD-rate increase for view 1 and view 2 (0.3% and 2.0% respectively). The BD-rate measure for the coded video PSNR with video bitrate, the coded video PSNR with total bitrate (texture bitrate and depth bitrate), and the synthesized video PSNR with total bitrate shows very small BD-rate increase or no increase (0.1%, 0.1% and 0% respectively). The encoding time, decoding time and rendering time are about the same as the conventional system.

TABLE 1

| | | | | Video | Video | Synth | | | |
|---|---|---|---|---|---|---|---|---|---|
| | | | | PSNR/video | PSNR/total | PSNR/total | Enc | Dec | Ren |
| | Video 0 | Video 1 | Video 2 | bitrate | bitrate | bitrate | time | time | time |
| Balloons | 0.0% | 0.1% | 0.0% | 0.0% | 0.0% | 0.0% | 100.5% | 96.5% | 101.4% |
| Kendo | 0.0% | 0.1% | 0.0% | 0.0% | 0.0% | 0.0% | 102.5% | 97.1% | 96.1% |
| Newspapercc | 0.0% | 0.0% | 0.1% | 0.0% | 0.0% | 0.1% | 102.4% | 100.8% | 100.1% |
| GhostTownFly | 0.0% | 0.6% | 0.5% | 0.1% | 0.1% | 0.1% | 102.7% | 108.0% | 100.6% |
| PoznanHall2 | 0.0% | 0.4% | 0.0% | 0.1% | 0.1% | 0.0% | 103.3% | 100.6% | 101.3% |
| PoznanStreet | 0.0% | 0.1% | 0.2% | 0.0% | 0.0% | 0.0% | 102.2% | 102.8% | 105.9% |
| UndoDancer | 0.0% | 0.8% | 0.7% | 0.2% | 0.2% | 0.1% | 99.8% | 90.9% | 101.3% |
| 1024 × 768 | 0.0% | 0.1% | 0.0% | 0.0% | 0.0% | 0.0% | 101.8% | 98.1% | 99.2% |
| 1920 × 1088 | 0.0% | 0.5% | 0.3% | 0.1% | 0.1% | 0.1% | 102.0% | 100.6% | 102.3% |
| average | 0.0% | 0.3% | 0.2% | 0.1% | 0.1% | 0.0% | 101.9% | 99.5% | 101.0% |

Another comparison is performed for a modified system and a conventional system based on HTM-8.0 as shown in Table 2. The modified system is based on HTM-8.0. However, the modified system disallows NBDV and VSP mode inheritance if the VSP-coded spatial neighboring block is above the boundary of the current LCU row. The modified system shows a small BD-rate increase for view 1 and view 2 (0.3% and 2.0% respectively). The BD-rate measure for the coded video PSNR with video bitrate, the coded video PSNR with total bitrate (texture bitrate and depth bitrate), and the synthesized video PSNR with total bitrate also shows no increase. The encoding time, decoding time and rendering time are about the same as the conventional system.

TABLE 2

| | | | | Video | Video | Synth | | | |
|---|---|---|---|---|---|---|---|---|---|
| | | | | PSNR/video | PSNR/total | PSNR/total | Enc | Dec | Ren |
| | Video 0 | Video 1 | Video 2 | bitrate | bitrate | bitrate | time | time | time |
| Balloons | 0.0% | 0.0% | 0.0% | 0.0% | 0.0% | −0.1% | 102.8% | 105.0% | 102.1% |
| Kendo | 0.0% | 0.1% | 0.1% | 0.0% | 0.0% | 0.0% | 100.2% | 96.8% | 97.3% |
| Newspapercc | 0.0% | 0.0% | 0.0% | 0.0% | 0.0% | 0.0% | 100.6% | 106.6% | 103.3% |
| GhostTownFly | 0.0% | 0.8% | 0.5% | 0.1% | 0.1% | 0.1% | 99.4% | 102.5% | 100.8% |
| PoznanHall2 | 0.0% | 0.3% | −0.1% | 0.0% | 0.0% | 0.0% | 99.3% | 96.1% | 101.9% |
| PoznanStreet | 0.0% | 0.1% | 0.1% | 0.0% | 0.0% | 0.0% | 102.0% | 102.9% | 104.3% |
| UndoDancer | 0.0% | 0.5% | 0.5% | 0.1% | 0.1% | 0.1% | 101.8% | 91.9% | 101.8% |
| 1024 × 768 | 0.0% | 0.0% | 0.0% | 0.0% | 0.0% | 0.0% | 101.2% | 102.8% | 100.9% |
| 1920 × 1088 | 0.0% | 0.4% | 0.2% | 0.1% | 0.1% | 0.0% | 100.6% | 98.4% | 102.2% |
| average | 0.0% | 0.3% | 0.2% | 0.0% | 0.0% | 0.0% | 100.9% | 100.3% | 101.6% |

Another embodiment incorporating unified depth data access for unified VSP process and VSP-based merging candidate derivation is compared to a conventional system based on HTM-8.0 as shown in Table 3. In this comparison, the unified depth data access method according to the present invention disallows NBDV and VSP mode inheritance if the VSP-coded spatial neighboring block is above the boundary of the current LCU row. The system incorporating embodiments of the present invention shows a small BD-rate increase for view 1 and view 2 (0.3% and 2.0% respectively). The BD-rate measure for the coded video PSNR with video bitrate, the coded video PSNR with total bitrate (texture bitrate and depth bitrate), and the synthesized video PSNR with total bitrate shows very small BD-rate increase or no increase (0.1%, 0% and 0% respectively). The encoding time, decoding time and rendering time are about the same as the conventional system.

TABLE 3

| | | | | Video | Video | Synth | | | |
|---|---|---|---|---|---|---|---|---|---|
| | | | | PSNR/video | PSNR/total | PSNR/total | Enc | Dec | Ren |
| | Video 0 | Video 1 | Video 2 | bitrate | bitrate | bitrate | time | time | time |
| Balloons | 0.0% | −0.1% | 0.0% | 0.0% | 0.0% | 0.0% | 102.4% | 107.6% | 101.6% |
| Kendo | 0.0% | 0.1% | 0.1% | 0.0% | 0.0% | 0.0% | 102.4% | 92.6% | 97.1% |
| Newspapercc | 0.0% | 0.1% | 0.0% | 0.0% | 0.0% | 0.0% | 104.3% | 101.8% | 106.9% |
| GhostTownFly | 0.0% | 1.0% | 0.8% | 0.2% | 0.2% | 0.1% | 101.8% | 104.2% | 102.6% |
| PoznanHall2 | 0.0% | 0.2% | −0.2% | 0.0% | 0.0% | −0.1% | 103.8% | 109.6% | 102.1% |
| PoznanStreet | 0.0% | 0.3% | 0.1% | 0.0% | 0.0% | 0.0% | 102.4% | 103.1% | 102.7% |
| UndoDancer | 0.0% | 0.8% | 0.7% | 0.2% | 0.2% | 0.2% | 102.6% | 91.5% | 102.7% |
| 1024 × 768 | 0.0% | 0.0% | 0.0% | 0.0% | 0.0% | 0.0% | 103.0% | 100.6% | 101.9% |
| 1920 × 1088 | 0.0% | 0.5% | 0.4% | 0.1% | 0.1% | 0.0% | 102.7% | 102.1% | 102.5% |
| average | 0.0% | 0.3% | 0.2% | 0.1% | 0.0% | 0.0% | 102.8% | 101.5% | 101.2% |

FIG. 8 illustrates an exemplary flowchart of three-dimensional or multi-view video encoding or decoding system that uses unified depth data access for VSP process and VSP-based merging candidate derivation. The system receives input data associated with a current texture CU (coding unit) in a dependent view as shown in step 810. The input data may correspond to un-coded or coded texture data. The input data may be retrieved from storage such as a computer memory, buffer (RAM or DRAM) or other media. The video bitstream may also be received from a processor such as a controller, a central processing unit, a digital signal processor or electronic circuits that produce the input data. A reference depth block in a reference view corresponding to the current texture CU is fetched using a derived DV (disparity vector) as shown in step 820. First VSP data for a current PU (prediction unit) within the current CU is generated based on the reference depth block as shown in step 830. Second VSP data for one or more VSP-coded spatial neighboring PUs associated with said one or more VSP spatial merging candidates is generated based on the reference depth block as shown in step 840. The current PU is then encoded or decoded using the first VSP data if the VSP mode is used, or encoding or decoding the current PU as the second VSP data if the Merge mode is used with the VSP merging candidate selected as shown in step 850.

The flowchart shown above is intended to illustrate examples of unified depth data access for VSP process and VSP-based merging candidate derivation. A person skilled in the art may modify each step, re-arranges the steps, split a step, or combine steps to practice the present invention without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be a circuit integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description.

All changes which come within the meaning and range of equivalency of the claims are to be embraced within their scope.

1. A method of video coding for a three-dimensional or multi-view video encoding or decoding system, wherein the three-dimensional or multi-view video encoding or decoding system utilizes coding tools comprising VSP (view synthesis prediction) mode and Merge mode with a merging candidate list including one or more VSP spatial merging candidates, the method comprising:
receiving input data associated with a current texture CU (coding unit) in a dependent view;
fetching a reference depth block in a reference view corresponding to the current texture CU using a derived DV (disparity vector);
generating first VSP data for a current PU (prediction unit) within the current CU based on the reference depth block;
generating second VSP data for one or more VSP-coded spatial neighboring PUs associated with said one or more VSP spatial merging candidates based on the reference depth block; and
encoding or decoding the current PU using the first VSP data if the VSP mode is used, or encoding or decoding the current PU as the second VSP data if the Merge mode is used with the VSP merging candidate selected.

2. The method of claim 1, wherein the derived DV corresponds to a selected DV derived from one or more neighboring blocks of the current texture CU.

3. The method of claim 1, wherein a selected DV is derived from one or more neighboring blocks of the current texture CU, and the derived DV is derived by converting selected depth data in the reference view pointed by the selected DV into the derived DV.

4. The method of claim 1, wherein said generating the first VSP data for the current PU comprises deriving first reference texture data in an inter-view reference picture corresponding to the current PU according to disparity converted from the reference depth block, and using the first reference texture data as the first VSP data.

5. The method of claim 1, wherein said generating second VSP data for the VSP-coded spatial neighboring comprises deriving second reference texture data in an inter-view reference picture corresponding to the current PU according to disparity converted from the reference depth block and using the second reference texture data as the second VSP data.

6. The method of claim 1, wherein said generating second VSP data for the VSP-coded spatial neighboring comprises deriving second reference texture data in an inter-view reference picture corresponding to the current PU according to disparity converted from the reference depth block and using the second reference texture data as the second VSP data.

7. The method of claim 1, wherein a partial set of said one or more VSP spatial merging candidates are checked for redundancy, wherein any redundant VSP merging candidate that is identical to another VSP merging candidate is removed from the merging candidate list.

8. The method of claim 1, wherein a full set of said one or more VSP spatial merging candidates are checked for redundancy, wherein any redundant VSP merging candidate that is identical to another VSP merging candidate is removed from the merging candidate list.

9. The method of claim 1, wherein if one VSP spatial merging candidate is located above a boundary of a current LCU (largest coding unit) row containing the current texture CU, said one VSP spatial merging candidate is excluding from being one VSP spatial merging candidate.

10. The method of claim 9, wherein said one VSP spatial merging candidate above the boundary of the current LCU row is treated as a common DCP candidate using associated DV and reference index stored for VSP-coded blocks.

11. The method of claim 1, wherein if one VSP spatial merging candidate is located outside a current LCU (largest coding unit) containing the current texture CU, said one VSP spatial merging candidate is excluding from being one VSP spatial merging candidate.

12. The method of claim 11, wherein said one VSP spatial merging candidate outside the current LCU is treated as a common DCP candidate using associated DV and reference index stored for VSP-coded blocks.

13. An apparatus for video coding in a three-dimensional or multi-view video encoding or decoding system, wherein the three-dimensional or multi-view video encoding or decoding system utilizes coding tools comprising VSP (view synthesis prediction) mode and Merge mode with a merging candidate list including one or more VSP spatial merging candidates, the apparatus comprising one or more electronic circuits configured to:
receive input data associated with a current texture CU (coding unit) in a dependent view;
fetch a reference depth block in a reference view corresponding to the current texture CU using a derived DV (disparity vector);
generate first VSP data for a current PU (prediction unit) within the current CU based on the reference depth block;
generate second VSP data for one or more VSP-coded spatial neighboring PUs associated with said one or more VSP spatial merging candidates based on the reference depth block; and
encode or decoding the current PU using the first VSP data if the VSP mode is used, or encoding or decoding the current PU as the second VSP data if the Merge mode is used with the VSP merging candidate selected.

14. The apparatus of claim 13, wherein the derived DV corresponds to a selected DV derived from one or more neighboring blocks of the current texture CU.

15. The apparatus of claim 13, wherein a selected DV is derived from one or more neighboring blocks of the current texture CU, and the derived DV is derived by converting selected depth data in the reference view pointed by the selected DV into the derived DV.

16. The apparatus of claim 13, wherein said generating the first VSP data for the current PU derives first reference texture data in an inter-view reference picture corresponding to the current PU according to disparity converted from the reference depth block to generate the first VSP data.

17. The apparatus of claim 13, wherein said second VSP data for the VSP-coded spatial neighboring derives second reference texture data in an inter-view reference picture corresponding to the current PU according to disparity converted from the reference depth block to generate the second VSP data.

18. The apparatus of claim 13, wherein said second VSP data for the VSP-coded spatial neighboring derives second reference texture data in an inter-view reference picture corresponding to the current PU according to disparity converted from the reference depth block to generate the second VSP data.

19. The apparatus of claim 13, wherein a partial set of said one or more VSP spatial merging candidates are checked for redundancy, wherein any redundant VSP merging candidate that is identical to another VSP merging candidate is removed from the merging candidate list.

20. The apparatus of claim 13, wherein a full set of said one or more VSP spatial merging candidates are checked for redundancy, wherein any redundant VSP merging candidate that is identical to another VSP merging candidate is removed from the merging candidate list.

21. The apparatus of claim 13, wherein if one VSP spatial merging candidate is located above a boundary of a current LCU (largest coding unit) row containing the current texture CU or located outside the current LCU, said one VSP spatial merging candidate is excluding from being one VSP spatial merging candidate.

22. The apparatus of claim 21, wherein said one VSP spatial merging candidate above the boundary of the current LCU row or outside the current LCU is treated as a common DCP candidate using associated DV and reference index stored for VSP-coded blocks.
